(19) United States
(12) Patent Application Publication
(10) Pub. No.: US 2018/0293288 A1
(43) Pub. Date: Oct. 11, 2018

(54) METHOD AND SYSTEM FOR DYNAMICALLY EXTENDABLE DISCIPLINES IN A MULTIDISCIPLINARY ENGINEERING SYSTEM

(71) Applicants: Siemens Aktiengesellschaft, Munich (DE); SIEMENS PRODUCT LIFECYCLE MANAGEMENT SOFTWARE INC., Plano, TX (US)

(72) Inventors: Oswin Noetzelmann, Diamond Bar, CA (US); Rami Reuveni, Irvine, CA (US); Attila Labas, Rancho Mission Viejo, CA (US); Marine Durel, Long Beach, CA (US); Michael Glass, Bonn (DE); Wilfried Barth, Leverkusen (DE); Andrew Dylla, Anaheim Hills, CA (US)

(21) Appl. No.: 15/577,987

(22) PCT Filed: Jun. 4, 2015
(86) PCT No.: PCT/US2015/034122

§ 371 Date: Nov. 29, 2017

(51) Int. Cl. G06F 17/30; G06Q 10/06; G06F 9/46

(52) U.S. Cl. CPC G06F 17/30569; G06F 17/3056; G06F 9/465; G06Q 10/0633; G06F 17/30607

(57) ABSTRACT

The disclosed embodiments include methods, systems and computer readable media for dynamically extendable disciplines in a multidisciplinary engineering system. The multidisciplinary engineering system is extended by adding a new engineering application 307 and engineering data associated with the new engineering application 307. The new engineering application data is linked to other engineering applications 307 in the multidisciplinary engineering system. Workflows are provided for accomplishing engineering tasks using the new and existing engineering data across engineering disciplines in the multidisciplinary engineering system.

### BACKGROUND

The present embodiments relate to multidisciplinary engineering systems. A multidisciplinary engineering system is a system that integrates multiple engineering disciplines, such as design engineering, electrical engineering, mechanical engineering, automation engineering, project management and the like, and allows engineers, technicians and managers from various disciplines to work on common or connected data. For example, factory designers work together with mechanical engineers, electrical engineers, automation engineers and managers to plan a new production line for a car door assembly. In a multidisciplinary engineering system, each discipline has its own representation of data. For example, the same device will be represented differently in each discipline, and different data regarding the device is stored depending on the discipline.

Existing engineering systems focus on serving a specific engineering discipline, typically using a dedicated engineering application. For example, a mechanical construction discipline and an electrical engineering discipline each have a standalone, discipline specific engineering application. Few existing engineering systems allow for integration of multiple engineering disciplines. Often, the systems that integrate multiple engineering disciplines are based on standalone, discipline specific engineering applications that interact through importing and exporting data and through manual workflows. Alternatively, existing meta-modeling tools allow for generic editing of data schemas and the creation of instances of these schemas. However, object-oriented programming or the use of programming tools is required to edit the data schemas.

### SUMMARY

By way of introduction, the preferred embodiments described below include methods, systems and computer readable media for dynamically extendable disciplines in a multidisciplinary engineering system. The multidisciplinary engineering system is extended by adding a new engineering application and engineering data associated with the new engineering application. The new engineering application data is linked to other engineering applications in the multidisciplinary engineering system. Workflows are provided for accomplishing engineering tasks using the new and existing engineering data across engineering disciplines in the multidisciplinary engineering system.

In a first aspect, a method is provided for dynamically extending a multidisciplinary engineering system to a new engineering discipline. A server stores data characteristics for engineered data in the multidisciplinary engineering system. The data characteristics include a data structure for engineering application objects, with the data structure including a data type and attributes of the data type. The data characteristics also include a data organization methodology for storing the engineering application objects and a data behavior methodology for accessing and manipulating the engineering application objects. A computer stores a new engineering application for the new engineering discipline. The computer defines new engineering application objects in the new engineering application satisfying the data characteristics stored on the server. The server links the new engineering application objects to existing engineering applications for existing engineering disciplines in the multidisciplinary engineering system. The server links existing engineering application objects in the multidisciplinary engineering system to the new engineering application. The computer defines workflows in the new engineering application for manipulating the new engineering application objects in the new engineering application.

In a second aspect, a multidisciplinary engineering system is provided for dynamically extending a multidisciplinary engineering system to a new engineering discipline. A server is configured to store data characteristics for engineered data in the multidisciplinary engineering system. The data characteristics include a data structure for the engineering application objects including a data type and attributes of the data type. The data characteristics also include a data organization methodology for storing the engineering application objects and a data behavior methodology for accessing and manipulating the engineering application objects. A workstation is configured to store a new engineering application for the new engineering discipline using to the data characteristics stored on the server. The workstation defines new engineering application objects in the new engineering application, links the new engineering application objects to existing engineering applications for existing engineering disciplines in the multidisciplinary engineering system, and links existing engineering application objects in the multidisciplinary engineering system to the new engineering application. The workstation defines workflows for manipulating the new engineering application objects in the new engineering application.

In a third aspect, a method is provided for dynamically extending a multidisciplinary engineering system to a new engineering discipline. A server stores data rules for engineered data in the multidisciplinary engineering system. The data rules include a data structure for the engineering data instances, with the data structure including a data type and attributes of the data type. The data rules also include a data organization methodology for storing the engineering data instances and a data behavior methodology for accessing and manipulating the engineering data instances. The server stores new engineering data instances for a new engineering application for the new engineering discipline in the multidisciplinary engineering system, with the new engineering data instances satisfying the data rules. The server links the new engineering data instances from the new engineering application to existing engineering applications for existing engineering disciplines in the multidisciplinary engineering system. The server links the existing engineering data instances in the multidisciplinary engineering system to the new engineering application. A computer accesses the new engineering data instances and the existing data instances with the new engineering application and the existing engineering applications.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 illustrates an example of a multidisciplinary engineering system.

FIG. 2 illustrates an example of engineered data in a multidisciplinary system.

FIG. 3 illustrates an example implementation of a multidisciplinary system.

FIG. 4 illustrates an embodiment of a system for dynamically extendable disciplines in a multidisciplinary engineering system.

FIG. 5 illustrates another embodiment of a system for dynamically extendable disciplines in a multidisciplinary engineering system.

FIG. 6 illustrates an example of a dynamically extended discipline in a multidisciplinary engineering system.

FIG. 7 is a flowchart diagram of an embodiment of a method for dynamically extending disciplines in a multidisciplinary engineering system.

### DETAILED DESCRIPTION OF EXEMPLARY EMBODIMENTS

The following embodiments describe a solution for extending a multidisciplinary engineering system to new engineering disciplines. A multidisciplinary engineering system is extended by adding a new engineering application and engineering data to the multidisciplinary engineering system. The new engineering data has characteristics such as data structures, data organizations and behaviors for the new engineering discipline. Extending the multidisciplinary engineering system to include the new engineering discipline allows the system to reuse the capabilities and functionality of the multidisciplinary engineering system to accomplish additional engineering tasks and workflows in the new engineering discipline as well as across engineering disciplines. For example, engineering data is associated between the different engineering disciplines, with each discipline benefiting from the shared engineering data. The shared engineering data is used to perform cross-discipline engineering workflows.

The following embodiments disclose adding a complete engineering discipline to a multidisciplinary engineering system. In an implementation, a building architecture design discipline is added to a multidisciplinary engineering system. The building architecture design data is represented in the multidisciplinary engineering system according to a data structure, a data organization and data behavior. The data structure for the building architecture design discipline includes characteristics of the new engineering data. Engineering data may also be referred to as application objects. For example, engineering data for the building architecture design discipline includes representations of walls, roofs, windows and doors of a building, and a static analysis for the building. An application object representing a wall includes properties for a physical description of the wall, including the wall's mass, building materials, etc. The application object for the wall is associated with other application objects in the multidisciplinary engineering system, such as application objects for other walls, application objects for other types of objects, such as roofs, windows, and doors, and application objects representing objects modeled in other engineering disciplines. The data organization for the architecture design discipline includes, for example, a hierarchical or graphical organization for the application objects. The building architecture design discipline includes a floor breakdown that organizes the application objects according to their corresponding location in a building. Alternatively, a static analysis breakdown organizes the application objects by static dependencies between the architectural objects represented by the application objects. Behavior in the building architecture design discipline includes, for example, workflows for modeling a building in the multidisciplinary engineering system, such as configuring application objects for walls, roofs, doors and windows in an architecture design application. The application objects also have specific behaviors. For example, a door can be opened or closed. The architecture design application, for example, is a mathematical static analysis tool, allowing engineers to incorporate sophisticated behaviors, such as a static analysis. The multidisciplinary engineering system may be extending to include different, additional, fewer, or other engineering disciplines and engineering specific applications. In the example above, an architecture discipline is added. In other embodiments, any of the disciplines mentioned herein or other disciplines are added to an already existing set of any number of other disciplines.

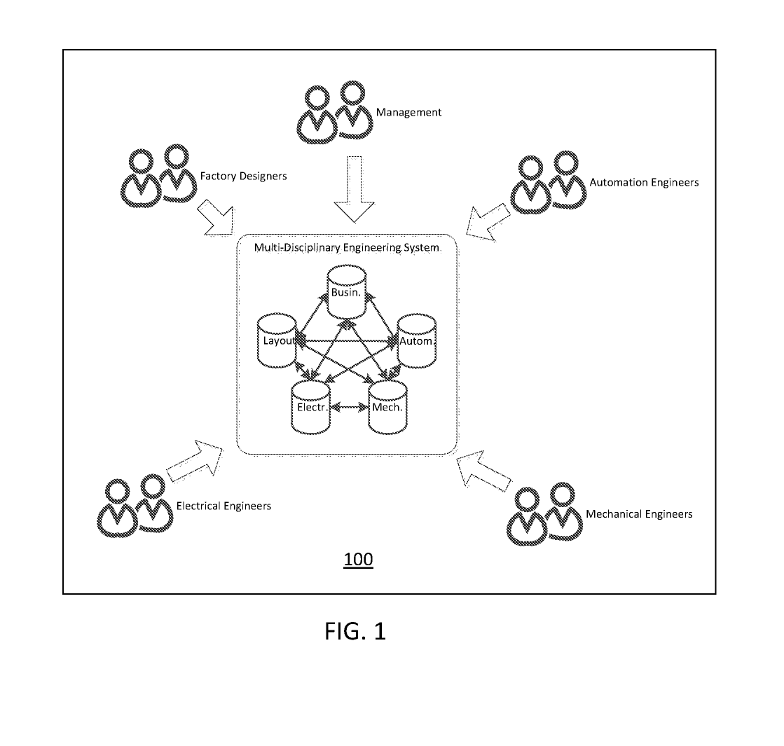

FIG. 1 illustrates an example of a multidisciplinary engineering system. The multidisciplinary engineering 100 includes a server and workstations. The server and/or workstations in the multidisciplinary engineering system 100 include engineering applications for various engineering disciplines. The engineering applications are directed to layout design, electrical design, mechanical design, automation design, and business functions. The engineering applications correspond to engineering disciplines, such as factory design, electrical engineering, mechanical engineering, automation engineering, and project management. Engineered devices and other objects are represented in the engineering applications in the multidisciplinary system, such as a conveyor on a factory assembly line. Each engineering application presents data differently, in a manner suited for the specific engineering discipline. Additional, different or fewer engineering applications and engineering disciplines may be provided. Alternatively, at least one of the engineering applications is directed to two or more engineering disciplines within a single application. Various engineers, designers, technicians, managers and other users access the engineering applications to complete tasks on the project. For example, in the context of an automobile factory, various engineers, designers and project managers plan a new production line for a car door assembly.

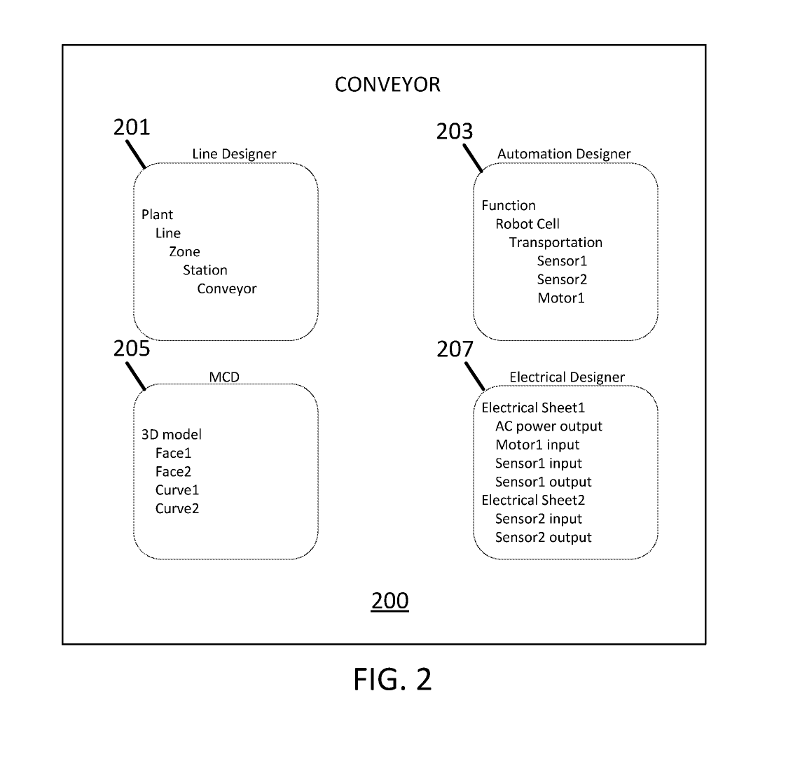

FIG. 2 illustrates an example of engineered data in a multidisciplinary system. In this example, a new production line includes the conveyor. Each engineering application 201, 203, 205 and 207 has a role with respect to the conveyor, and will have a different representation of data associated with the conveyor that is specific to the engineering application. Referring to FIG. 2, factory designers utilize a layout design application, such as line designer application 201, to plan the layout of the new production line, including the conveyor. The line designer application 201 displays information about the new production line, including the plant, line, zone and station where the conveyor will be placed. Automation engineers utilize the automation designer application 203 to plan the conveyor automation. Automation designer application 203 displays the function and robot cell of the conveyor, and the components of the conveyor that will be automated, including sensor1, sensor2 and motor1. Mechanical engineers utilize a mechanical design application, such as MCD 205, to plan the mechanical aspects of the conveyor. MCD 205 includes information about a three-dimensional (3D) model of the conveyor, including face1, face2, curve1 and curve2. Electrical engineers utilize the electrical designer application 207 to plan the electrical inputs and outputs for the conveyor. Electrical designer application 207 displays electrical information that will be provided to technicians installing the conveyor. Electrical sheet 1 includes an AC power output, motor1 input, sensor1 input and sensor1 output. Electrical sheet 2 includes a sensor2 input and sensor2 output. Additional and different roles and/or information may be provided.

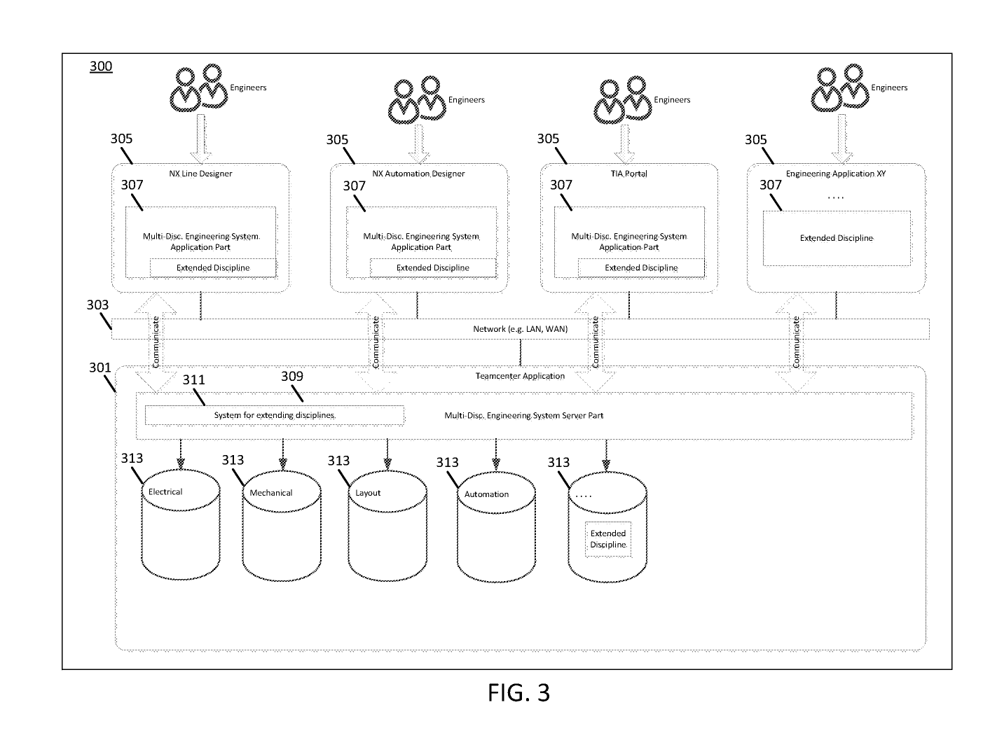

FIG. 3 illustrates an example implementation of a multidisciplinary system. In one embodiment, the multidisciplinary system is the Siemens Engineering Environment utilizing Siemens engineering tools and applications. Additional implementations may be provided in the same or other engineering systems.

The multidisciplinary system 300 includes a server 301, a network 303 and workstations 305. Additional, different, or fewer components may be provided. For example, more or fewer workstations 305 are used. As another example, additional networks and/or servers are used. In yet another example, a separate database managed or accessed by the server 301 or the workstations 305 is provided. Alternatively, the server 301 and the workstations 305 are directly connected, or implemented on a single computing device. Additionally, the server 301 can be a single physical server, a system of servers, a virtual server, as used in cloud computing and virtualization scenarios, or a system of virtual servers.

The server 301 includes a Teamcenter application 309 with a system for extending engineering disciplines 311 and databases 313. Alternatively, the system for extending engineering disciplines 311 may be hosted on the workstations 305. The system for extending engineering disciplines 311 allows extends the multidisciplinary engineering system to a new discipline 307 that is used to fulfill engineering tasks that are associated with the new engineering discipline. The Teamcenter application 309 allows a user extend the multidisciplinary engineering system by adding, deleting or modifying engineering applications stored on server 301 and/or workstations 305. The Teamcenter application 309 stores engineering data for each engineering discipline in the databases 313. Additional, different, or fewer components may be provided. For example, the Teamcenter application 309 may be uploaded to, and executed by, a processor in server 301. Likewise, processing strategies may include multiprocessing, multitasking, parallel processing and the like. The server 301 is implemented on a computer platform having hardware such as one or more central processing units (CPU), a random access memory (RAM), and input/output (I/O) interface(s). The computer platform also includes an operating system and microinstruction code. The various processes and functions described herein may be either part of the microinstruction code or part of the program (or combination thereof) which is executed via the operating system. Alternatively, the server 301 includes one or more processors in a network.

The Teamcenter application 309 also serves as a meta-model based repository system and data platform for the engineering applications 307 by storing data received from the engineering applications 307 in the databases 313. The data received from the engineering applications 307 includes project specific data, such as object and parameter names, parameter values, device specifications, and/or other information. The Teamcenter application 309 operates as a multidisciplinary system server that communicates information to/from the engineering applications 307 over the network 303. The databases 313 store engineering data for the various engineering applications. The Teamcenter application 309 also stores a library of application objects and the links and connections between application objects.

The multidisciplinary system 300 includes workstations 305 with engineering applications 307 corresponding to various engineering disciplines and engineering roles. The engineering applications 307 access engineering data for the existing and extended disciplines that is stored on the server 301. For example, NX Line Designer is a layout design application, such as the line designer application 201, NX Automation Designer is an automation engineering application, such as automation designer application 203, NX MCD is a three-dimensional (3D) modeling application, such as MCD 205, and NX Electrical Designer is an electrical engineering application, such as electrical designer application 207. Different or fewer engineering applications, engineering disciplines and engineering roles may be provided. A new engineering application is referred to as Engineering Application XY, corresponding to an extended engineering discipline XY added to the multidisciplinary engineering system. Various engineers, designers, technicians, managers and other users access the engineering applications, such as line design engineers, automation engineers, MCD engineers and XY engineers.

The multidisciplinary system 300 includes a network 203. The network 203 is a wired or wireless network, or a combination thereof. The network 203 is configured as a local area network (LAN), wide area network (WAN), intranet, internet or other now known or later developed network configurations. Any network or combination of networks for communicating between the role-specific applications and the server for hosting the templates, data, or other information of the engineering system may be used.

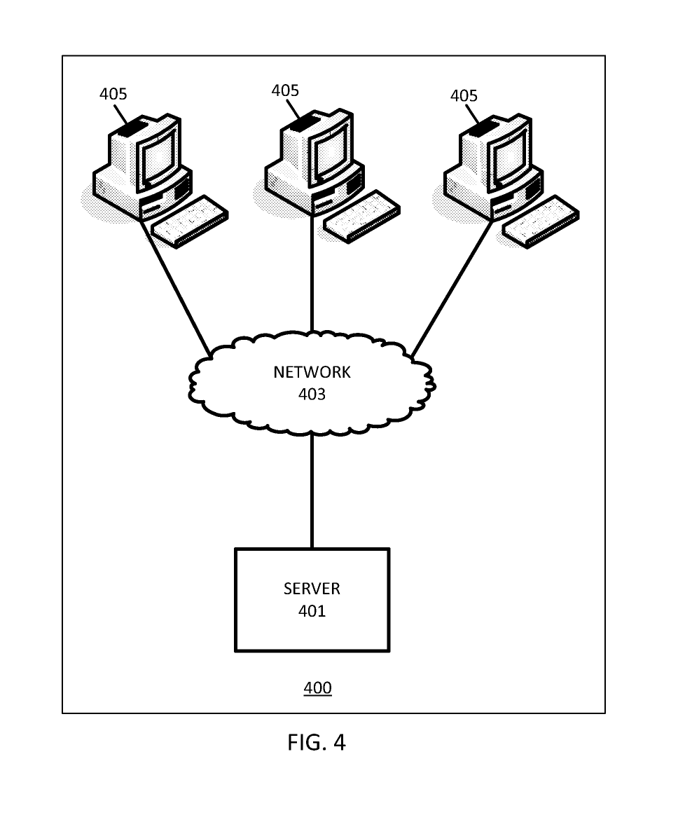

FIG. 4 illustrates an embodiment of a system for dynamically extendable disciplines in a multidisciplinary engineering system. The multidisciplinary system 400 includes a server 401, a network 403 and workstations 405. Additional, different, or fewer components may be provided. For example, additional or fewer workstations 405 are used. As another example, additional networks and/or servers are used. In yet another example, separate databases are managed and/or accessed by the server 401 and workstations 405. Server 401 is a server computer platform having hardware such as one or more central processing units (CPU), a system memory, a random access memory (RAM) and input/output (I/O) interface(s). The server 401 is implemented on one or more server computers connected to network 403. Additional, different or fewer server components may be provided.

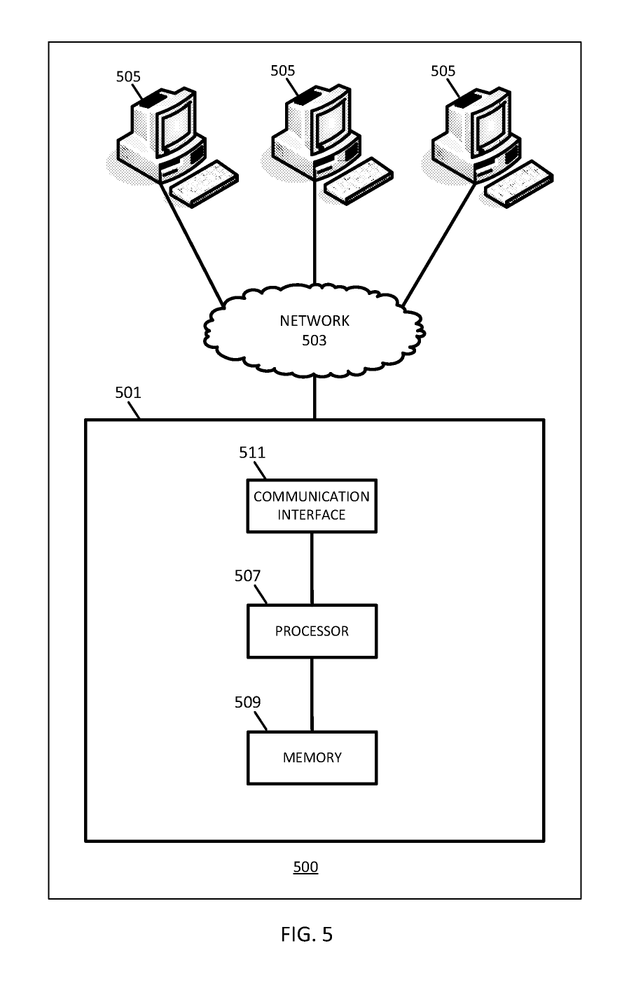

The server 401 is configured to store data characteristics and/or rules for engineered data in the multidisciplinary engineering system for a new engineering discipline. For example, a building architecture design discipline is added to the multidisciplinary engineering system 400. The new engineering discipline includes a new engineering application and engineering data associated with the new engineering application. The workstations 405 access, display and modify the engineering data and engineering application associated with the new engineering discipline. The server 401 may transmit the new engineering application and the new engineering data to one or more workstations 405. Alternatively, as illustrated in FIG. 5, the server 501 accesses, displays and modifies the engineering data and engineering application associated with the new engineering discipline. The new engineering application and engineering data may be stored on one or more workstations 505, the server 501 or a combination thereof. In yet another alternative, the server 401 is implemented by one or more workstations 405 so that one or more of the engineering applications host the server functions.

A new engineering discipline is represented in a multidisciplinary engineering system with the following engineering data characteristics and/or rules: data structures; data organization; and behaviors. Additional, different, or fewer characteristics may be used. The data characteristics and/or rules are stored on the server 401. Alternatively, data characteristics and/or rules are stored on the workstations 405, or a combination of the workstations 405 and the server 401.

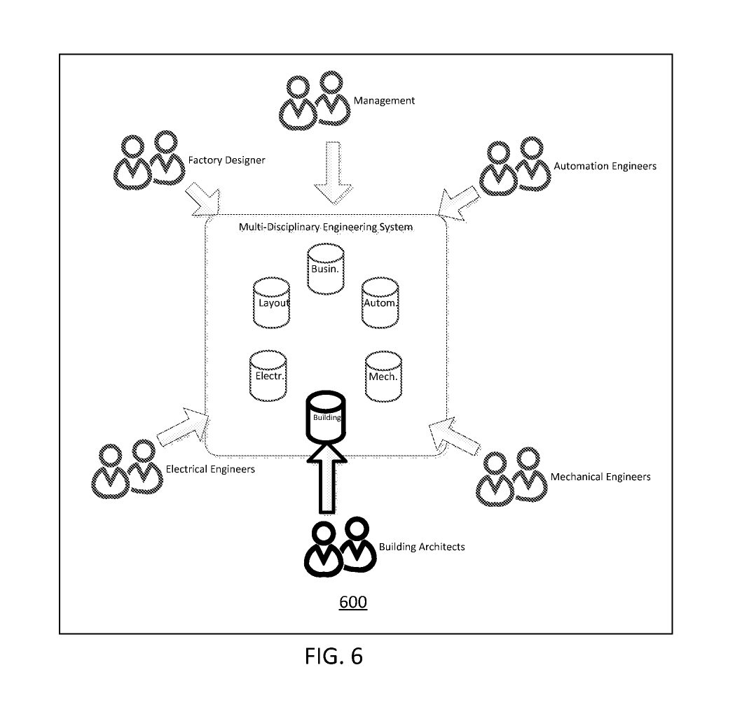

Data structures prescribe how new engineering data will exist when the new engineering data is added to the multidisciplinary engineering system extending the multidisciplinary engineering system to the new engineering discipline. When added, the new engineering data, also referred to as engineering application objects, is associated with a new engineering application for the new engineering discipline. The new engineering application is also added to the multidisciplinary engineering system when the multidisciplinary engineering system is dynamically extended to the new engineering discipline. For example, FIG. 6 illustrates an example of a dynamically extended discipline in a multidisciplinary engineering system. As shown in FIG. 6, the multidisciplinary engineering system 100 of FIG. 1 is extended to include a new building architecture design application in the extended multidisciplinary engineering system 600. The new engineering data is accessed by the new and existing engineering applications in the multidisciplinary engineering system to perform engineering tasks and workflows. For example, building architects access the new building architecture design application to complete tasks in an engineering project.

The new engineering data represents physical and/or non-physical objects that are represented in the multidisciplinary engineering system for the new engineering discipline. Data structures prescribe engineering constructs for the new engineering data as the engineering data is added, modified and used by the multidisciplinary engineering system. For example, a data structure for new engineering data specifies a data type, name, description, attributes, data fields and potential connectivity to other engineering data and/or engineering applications. Interfaces (i.e., ports) and connections establish relationships between application objects in the multidisciplinary engineering systems. The data structures can be specialized with additional attributes to include specific engineering data fields, attributes, interfaces and connections to other engineering data. The data structures also specify which engineering applications can view, modify and/or use the new engineering data and how the engineering data is displayed, modified and/or used.

In the building architecture design discipline example, data structures are added to a multidisciplinary engineering system for the building architecture design application. For example, data structures are provided for the new application objects (i.e., the engineering data) representing physical objects, such as walls, roofs, windows, and doors, and non-physical objects, such as a static analysis. Application objects for other physical and non-physical objects may be provided. In this example, an application object representing a wall has a data field for properties of the wall, such as a physical description of the wall (i.e., a mass, building material, etc.). Additionally, interfaces and connections with other applications in the building design application are provided, such as connections to other walls, a roof, windows and doors. Further, interfaces and connections with application objects in other engineering design applications are provided, such as connections to application objects representing three-dimensional bodies in the mechanical construction domain.

Data organization prescribes how the new engineering data will be stored in the multidisciplinary engineering system. Data organization provides a methodology for storing the new engineering data, and how the engineering data will be organized (e.g., organized in a manner to provide clarity for displaying and managing a large amount of engineering data). For example, one methodology for data organization is a data hierarchy or a data graph. In the data hierarchy example, the data is organized according to IEC 81346. IEC 81356 provides an organizational structure for data in multiple hierarchies referred to as aspects. In an IEC 81346 compliant system, the multidisciplinary engineering system is extended to a new engineering discipline by adding engineering data for the new discipline according to the hierarchical organization scheme. Alternatively, a new hierarchical organization is added by providing a specific node to an existing hierarchy for the new engineering discipline (e.g. in an IEC 81346 compliant aspect). The new node serves as the root node for the new engineering data associated with the new engineering discipline, and all engineering data associated with the new discipline is organized under this root node.

In the building architecture design discipline example, data organization is provided for the new application objects (i.e., the engineering data). For example, a new hierarchical or graphical organization for the building architecture design application is provided in a floor breakdown. The floor breakdown organizes the new application objects according to the corresponding floor where the physical objects represented by the application objects are located in a building. Additionally, a static analysis breakdown that organizes the new application objects by static dependencies between the physical objects represented by the application objects.

Data behaviors prescribe a methodology for accessing and manipulating the new engineering data after the new engineering data is added to the multidisciplinary engineering system. Each engineering discipline includes engineering tasks, and the steps for accomplishing the tasks. The steps are provided in one or more workflows. To complete the workflows and accomplish the engineering tasks, the multidisciplinary engineering system provides specific behaviors for viewing, manipulating or connecting the engineering data. For example, a workflow prescribes the steps for manipulating engineering data representing three-dimensional shapes in a mechanical design application. Another example is a workflow prescribing the steps for editing PLC code in an automation design application. Data behaviors for the new engineering data includes a methodology for acquiring temporary ownership over the new engineering data before modifying or otherwise manipulating the engineering data to prevent conflicting changes from being made by two or more users modifying the engineering data concurrently.

New data behaviors are introduced in various ways allowing the engineering steps to be accomplished. Data behaviors are provided for the new application object types, such as by using specified extension points (e.g. through providing a script or executable software component that is executed when an application object is created, deleted or utilized). For example, in a platform for multidisciplinary collaboration, the extension points are implemented by custom server code that executes in the context of an engineering domain data model (e.g., behavior attached to the engineering domain). In this example, server code libraries link with server interface libraries. Additionally, in an engineering application, there is a system (e.g., NX Open) that allows for scripting or programming in the engineering application runtime data model in various programming languages (e.g., C++, Java, .Net, Python, etc.), extending the behavior of the client data model. Alternatively, engineering applications use the data stored in the multidisciplinary engineering system through interfaces with the data, such as using a service oriented architecture. For example, a service oriented architecture (SOA) is a technique where a client-server system connects clients to the server in a formalized way (e.g., via a service). The service interface is provided in a known language (e.g., Web Service Definition Language (WSDL)). A SOA based system provides for extensibility, allowing the system to add new services without disrupting existing services.

In the building architecture design discipline example, data behaviors are added to a multidisciplinary engineering system for the building architecture design application. For example, workflows for modeling basic architectures with application objects representing walls, a roof, doors, windows, etc. is prescribed. Further, sophisticated data behaviors are prescribed for conducting a static analysis using the application objects. Additionally, the application objects have specific behaviors. For example, an application object representing a door includes a behavior for the door (e.g., the door can be opened or closed).

In an embodiment, the multidisciplinary engineering system provides a generic base data type that is used when extending the multidisciplinary engineering system to a new engineering discipline. The generic base data type is configurable to define new application objects. The generic base data type includes basic functionality for storing engineering data and for embedding the engineering data in the multidisciplinary engineering system. The generic base data type also includes a configurable data structure for new application objects, a configurable data organization for the new application objects and configurable data behaviors for the new application objects. For example, the generic base data type includes has the ability to exist in multidisciplinary engineering system, and has basic properties and behaviors, such as data type, name, description and lifecycle (i.e., multiple revisions). The generic base data type also includes multiuser capabilities, such as temporary ownership and access control for the new application objects allowing multiple users and engineering applications to access, modify and/or use the new application objects. The generic base data type also includes the ability to organize the application object into a new or existing hierarchy or graph, and the ability to interface with other application objects in the multidisciplinary engineering system. The generic base data type further includes the ability to store datasets and additional data files associated with the application objects. Different, fewer or additional functionalities may be included in the generic base application object.

Referring again to FIG. 4, workstations 405 are in communication with the server 401 over a network 403. One or more workstations 405 are configured to store the new engineering application for the new engineering discipline. Alternatively, the new engineering application is stored on the server 401, or a combination of the workstations 405 and the server 401.

New engineering application objects are defined in the new engineering application executed by the workstations 405. The new application objects are defined according to the data characteristics and/or rules stored on the server 401. Alternatively, the new application objects are defined in the new engineering application executed by the server 401, or executed by a combination of the workstations 405 and the server 401. For example, using the generic base data type described above, new application objects are defined for the new engineering application. In the building architecture design discipline example the generic base data type is adapted to define new application objects for the physical and non-physical objects associated with the building architecture design discipline. In one instance, the generic base data type is adapted to define an application object for a wall. The data structure for the wall is configured to include the physical description of the wall (i.e., a mass, building material, etc.) and to include interfaces for connectivity to other application objects and engineering applications. The data organization for the wall is configured to be included in a floor breakdown data hierarchy in the building architecture design application. Data behaviors are configured for the wall, such as the wall is connected to other walls and the wall partially supports a roof in a static analysis. The new application object for the wall is configured to include permissions for which of the existing engineering applications can access and manipulate the data associated with the wall. Different, fewer or additional functionalities may be configured in the generic base application object.

The new application objects are linked to existing engineering applications in the multidisciplinary engineering system. The existing engineering applications are associated with existing engineering disciplines in the multidisciplinary engineering system. The existing engineering application objects associated with the existing engineering applications are also similarly linked to the new engineering application. In one example, connections are defined between the interfaces (i.e., ports) in various application objects linking the application objects. According to the connections, one or more engineering objects, or engineering applications, receive data from an application object according to the connections established between the interfaces defined in the various application objects. The new application objects are linked automatically based on the data characteristics and/or rules for engineered data in the multidisciplinary engineering system, or manually by a user when defining the new application objects. In another example, engineering objects are grouped in clusters of engineering objects for a specific engineering purpose, such as a data for a group of devices included in a safety area of an automated facility, data for a group of devices included in an automation system, or data for a group of devices that are assigned to a specific bus controller. Accordingly, one or more engineering applications can access, view and modify the cluster of engineering objects. Additionally, the engineering applications can directly access the engineering application objects stored on the server 401. The server 401 serves as a repository for the engineering data associated with the engineering applications in the multidisciplinary engineering system. The application objects are configured to include permissions for which of the existing engineering applications can access and manipulate the data associated with each application object, linking the application objects to specific engineering applications. The linking between engineering applications is supported on at least two levels. In an example, the linking is performed by a sub-system, such as multidisciplinary object (MDO) sub-system. The MDO sub-system allows engineering objects to point to other engineering objects, linking the engineering objects together into a pool of objects. The pool of objects represents a single physical object with multiple discipline specific applications representing the physical object. For example, a first level facilitates linking reusable engineering data instances between engineering applications in a library context, supporting and restricting the linking of reusable engineering data instances stored in an object library. A second level facilitates linking of engineering data instances in engineering project context, supporting modeling a project by reusing engineering data from object libraries.

Linking new and existing application objects and engineering applications allows for multidisciplinary workflows to be prescribed for accomplishing multidisciplinary engineering tasks. Linking new and existing application objects and engineering applications also allows for change management, status and verification checks to be performed across disciplines enabling users to be notified of conflicting, incorrect or missing data. In the building architecture design discipline example, new application objects in the building architecture design application are linked to the line design application. The building architecture design application models the physical characteristics of a new factory building. The line design application models a factory layout to be installed in the new factory building. The new application objects in the building architecture design application representing the walls of the new factory building are linked to line design application in one or more of the manners described above, allowing the line design application to reuse the new application objects when planning a factory layout in the line design application. For example, the line design application reuses the engineering application objects representing walls in the new factory building to calculate square footage available for the factory layout. A multidisciplinary workflow may be prescribed for planning a factory layout as follows. Application objects are defined for the walls of the new factory building in the building design application. Next, application objects are defined for the factory layout in the line design application, utilizing the information provided from the building design application.

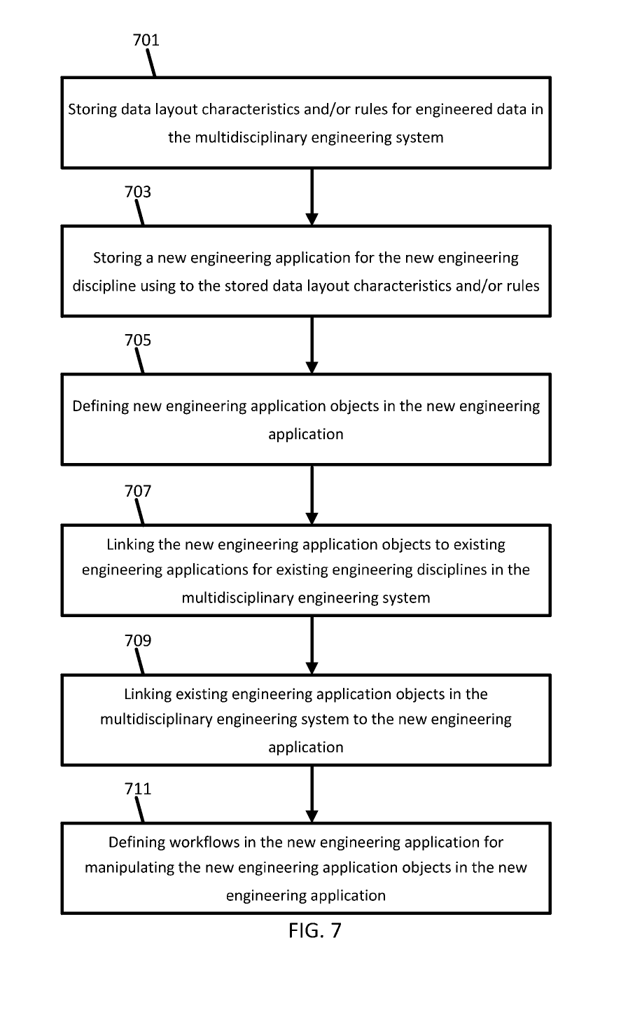

FIG. 7 is a flowchart diagram of an embodiment of a method for dynamically extending disciplines in a multidisciplinary engineering system. The method is implemented by the system of FIG. 3, 4, 5 and/or a different system. A processor or group of networked processors perform the acts, such as pursuant to instructions, programming or circuit design. Additional, different or fewer acts may be provided. The method is provided in the order shown. Other orders may be provided and acts may be repeated.

At act 701, data characteristics and/or rules for engineered data in the multidisciplinary engineering system are stored on a server, workstation, computer, engineering application, or other location. The data characteristics and/or rules include one or more data structures for new engineering objects, one or more data organization methodologies for storing the new engineering objects and data behaviors for the new engineering objects and data behaviors for accessing and manipulating the new engineering application objects. For example, in a new building architecture design discipline, data structures, data organization methodologies and data behaviors are provided. Data structures are provided for application objects for engineering data representing physical objects, such as walls, roofs, windows, and doors, and non-physical objects, such as a static analysis. Data organization methodologies are provided, such as a hierarchical floor breakdown, a hierarchical static analysis breakdown and an object graph. Data behaviors are provided, such as workflows for modeling basic architectures with application objects representing walls, a roof, doors, windows, etc., and specific behaviors for application objects, such as a behavior for the door that that it can be opened or closed.

At act 703, a new engineering application for the new engineering discipline is stored on a server, workstation, computer, engineering application, or other location. The new engineering application extends the multidisciplinary engineering system to the new engineering discipline. The new engineering application is accessed and/or executed by on a server, workstation, computer, engineering application, or other location. For example, in the new building architecture design discipline, the architecture design application is a mathematical static analysis tool, allowing engineers to incorporate sophisticated behaviors, such as a static analysis.

At act 705, new engineering application objects are defined in the new engineering application using to the stored data characteristics and/or satisfying the stored data rules. The new engineering application objects are defined on a server, workstation, computer, engineering application, or other location. In an embodiment, defining the new application objects comprises adding new nodes to the hierarchal tree representing the engineering data in the multidisciplinary engineering system. Defining the new application objects may also include identifying which of the existing engineering applications can access and manipulate the new application objects. For example, in the new building architecture design discipline, new application objects are provided representing walls, roofs, windows, doors and a static analysis of a building.

At act 707, the new engineering application objects are linked to existing engineering applications for the existing engineering disciplines in the multidisciplinary engineering system. The new engineering application objects are linked by a server, workstation, computer, engineering application, or other location. In an embodiment, linking the new engineering application objects to the existing engineering applications includes establishing a connection between interfaces in a new engineering application objects with interfaces in an existing engineering application objects. According to the connections, one or more engineering objects, or engineering applications, receive data from an application object according to the connection established between the interfaces defined in the various application objects. The new application objects are linked automatically based on the data characteristics and/or rules for engineered data in the multidisciplinary engineering system, or manually by a user when defining the new application objects. In another example, engineering objects are grouped in clusters of engineering objects for a specific engineering purpose. Additionally, the engineering applications can directly access the engineering application objects stored on the server 401. With respect to the new building architecture design discipline example, new application objects represented in the building architecture design application are linked to the line design application. The linked application objects allow the line design application to reuse the engineering data represented in the architecture design application for planning a factory layout in the line design application.

At act 709, existing engineering application objects in the multidisciplinary engineering system are linked to the new engineering application. The existing engineering application objects are linked by a server, workstation, computer, engineering application, or other location in the same manner as act 707. For example, with respect to the new building architecture design discipline example, existing application objects represented in the line design application are linked and represented in the architecture design application. The linked application objects allow the architecture design application to reuse the engineering data represented the line design model for planning a building to house the factory layout represented in the line design application.

At act 711, workflows in the new engineering application are defined for manipulating the new engineering application objects. In an embodiment, the defined workflows require acquiring temporary ownership over the new engineering application objects by a user before manipulating the engineering data. Temporary ownership in the multidisciplinary engineering system prevents concurrent users from making conflicting changes to application objects. For example, in a new building architecture design discipline, workflows are provided for modeling basic architectures with application objects representing walls, a roof, doors, windows, etc. Additionally, cross-disciplinary workflows are provided for accomplishing multidisciplinary engineering tasks, and also allowing for change management, status and verification checks to be performed across disciplines enabling users to be notified of conflicting, incorrect or missing data.

Dynamically extending disciplines in a multidisciplinary engineering system may result in reduced engineering efforts by integrating more engineering disciplines to benefit from the functionality of the multidisciplinary engineering system and by reducing the total effort for the engineers to realize an engineering project by taking advantage of data management and consistency across engineering disciplines. Dynamically extending disciplines in a multidisciplinary engineering system may result in shorter time to market because dynamically extending disciplines may increase the efficiency of the engineering processes by allowing for bulk operations across disciplines. Dynamically extending disciplines in a multidisciplinary engineering system may enhance the quality of the output of the overall engineering process by avoiding human introduced data synchronization errors in interdisciplinary workflows. Greater integration with existing engineering applications may be provided because it is possible to adapt this system and method to existing and future multidisciplinary engineering systems. The aforementioned advantages may result in investment savings and reduced risks, especially for large engineering companies that use set processes and standards. Some example industries that may benefit from the disclosed embodiments are automobile, logistics and machine building. However other industries may also benefit from the disclosed embodiments. The following examples and embodiments are exemplary of automation and mechanical disciplines, but many more example implementations can be used in all of the various engineering disciplines.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A method for dynamically extending a multidisciplinary engineering system to a new engineering discipline, the method comprising:
storing 701, by a server 301, data characteristics for engineered data in the multidisciplinary engineering system, the data characteristics comprising:
a data structure for engineering application objects, wherein the data structure comprises a data type and attributes of the data type;
a data organization for storing the engineering application objects;
a data behavior for accessing and manipulating the engineering application objects;
storing 703, by a computer 305, a new engineering application 307 for the new engineering discipline;
defining 705, by the computer 305, new engineering application objects in the new engineering application 307 satisfying the data characteristics stored on the server 301;
linking 707, by the server 301, the new engineering application objects to existing engineering applications 307 for existing engineering disciplines in the multidisciplinary engineering system; and
linking 709, by the server 301, existing engineering application objects in the multidisciplinary engineering system to the new engineering application 307.

2. The method of claim 1 wherein storing 701 the data characteristics for engineering data comprises storing the data characteristics with the attributes of the data type comprising an engineering data field.

3. The method of claim 1 wherein storing 701 the data characteristics for engineering data comprises storing the data characteristics with attributes of the data type comprising an interface relationship with engineering applications in the multidisciplinary engineering system.

4. The method of claim 1 wherein storing 701 the data characteristics for engineering data comprises storing the data characteristics with the data organization being a hierarchal tree representing the engineering application objects in the multidisciplinary engineering system.

5. The method of claim 1 wherein storing 701 the data characteristics for engineering data comprises storing the data characteristics with the data behavior comprises acquiring temporary ownership over an engineering application object before manipulating the engineering application object.

6. The method of claim 1 wherein defining 705 new application objects comprises adding new nodes to a hierarchal tree representing the engineering data in the multidisciplinary engineering system.

7. The method of claim 1 wherein defining 705 new application objects comprises identifying which of the existing engineering applications 307 can manipulate the new application objects.

8. The method of claim 1 wherein linking 707 the new engineering application objects to the existing engineering applications 307 comprises linking an interface in the new engineering application objects with an interface in the existing engineering application 307.

9. The method of claim 1 further comprising:
defining 711, by the computer 305, workflows in the new engineering application 307 for manipulating the new engineering application objects in the new engineering application 307.

10. A multidisciplinary engineering system for dynamically extending a multidisciplinary engineering system to a new engineering discipline, the system comprising:
a server 301 configured to:
store data characteristics for engineered data in the multidisciplinary engineering system, the data characteristics comprising:
a data structure for the engineering application objects, wherein the data structure comprises a data type and attributes of the data type;
a data organization methodology for storing the engineering application objects;
a data behavior methodology for accessing and manipulating the engineering application objects;
a workstation 305 configured to:
store a new engineering application 307 for the new engineering discipline;
define new engineering application objects in the new engineering application 307 satisfying the data characteristics stored on the server 301;
link the new engineering application objects to existing engineering applications 307 for existing engineering disciplines in the multidisciplinary engineering system;
link existing engineering application objects in the multidisciplinary engineering system to the new engineering application 307; and
define workflows for manipulating the new engineering application objects in the new engineering application 307.

11. The system of claim 10 wherein the attributes of the data type comprise an engineering data field.

12. The system of claim 10 wherein the attributes of the data type comprise an interface relationship with another engineering application object in the multidisciplinary engineering system.

13. The system of claim 10 wherein the data organization methodology comprises an object graph representing the engineering application objects in the multidisciplinary engineering system.

14. The system of claim 10 wherein the data behavior methodology comprises acquiring temporary ownership over an engineering application object before manipulating the engineering application object.

15. The system of claim 10 wherein the attributes of the data type comprise permissions for which of the existing engineering can manipulate the new application objects.

16. The system of claim 10 wherein the workflows for manipulating the new engineering application objects comprise acquiring temporary ownership over the new engineering application objects before manipulating the new engineering application objects.

17. A method for dynamically extending a multidisciplinary engineering system to a new engineering discipline, the method comprising:
storing 701, by a server 301, data rules for engineered data in the multidisciplinary engineering system, the data rules comprising:
a data structure for the engineering data instances, wherein the data structure comprises a data type and attributes of the data type;
a data organization methodology for storing the engineering data instances;
a data behavior methodology for accessing and manipulating the engineering data instances;
storing 703, by the server 301, new engineering data instances for a new engineering application 307 for the new engineering discipline in the multidisciplinary engineering system, wherein the new engineering data instances satisfy the data rules;
linking 707, by the server 301, the new engineering data instances from the new engineering application 307 to existing engineering applications for existing engineering disciplines in the multidisciplinary engineering system;
linking 709, by the server 301, the existing engineering data instances in the multidisciplinary engineering system to the new engineering application 307; and
accessing, with a computer 305, the new engineering data instances and the existing data instances with the new engineering application 307 and the existing engineering applications 307.

18. The method of claim 17 further comprising:
Storing 711, by the computer 301, workflows in the new engineering application 307 for manipulating the new engineering data instances in the new engineering application 307.

19. The method of claim 18 wherein the stored workflows comprise acquiring temporary ownership over the new engineering data instances before manipulating the new engineering data instances.

20. The method of claim 17 wherein linking 707 the new engineering data instances to the existing engineering applications 307 comprises linking an interface in the new engineering application objects with an interface in the existing engineering application 307.
